(19) United States
(12) Patent Application Publication
(10) Pub. No.: US 2024/0101345 A1
(43) Pub. Date: Mar. 28, 2024

(54) Smart Waste Container System

(71) Applicant: InnovationLab GmbH, Heidelberg (DE)

(72) Inventors: Jean-Nicolas Tisserant, Heidelberg (DE); Janusz Schinke, Ludwigshafen (DE); Alexey Sizov, Mannheim (DE); Kevin Schmid, Heidelberg (DE)

(21) Appl. No.: 18/038,502

(22) PCT Filed: Nov. 24, 2021
(86) PCT No.: PCT/EP2021/082841

§ 371 Date: May 24, 2023

(30) Foreign Application Priority Data
Nov. 24, 2020 (LU) 102216

(51) Int. Cl. B65F 1/14; G01F 23/80

(52) U.S. Cl. CPC B65F 1/14; G01F 23/802; B65F 2210/124; B65F 2210/128; B65F 2210/1443; B65F 2210/168

(57) ABSTRACT

A container system (10, 110) and a method for calculating (S6) a current fill status (64_CURR) of a container (30) using a plurality of presence sensor interactions (34) is disclosed. The container system (10, 110) comprises a presence sensor arrangement (32, 132) for calculating (S6) the plurality of presence sensor interactions (34) with the container (30); a local counting unit (40) for recording (S2) numbers of the plurality of presence sensor interactions (34) as presence sensor interaction data (36); and a local communication unit (60) for transmitting (S3) the presence sensor interaction data (36) to a remote processing unit (55) for calculating (S6) the current fill status (64 CURR).

This application is a U.S. national stage of International Application No. PCT/EP2021/082841 filed on Nov. 24, 2021, which claims priority to Luxemburg Patent Application LU102216, which was filed on Nov. 24, 2020. The entire disclosures of the above-referenced applications are hereby incorporated herein by reference in their entirety.

### BACKGROUND OF THE INVENTION

### Field of the Invention

The field of the invention relates to a system and a method for calculating a fill level of a container.

### Brief Description of the Related Art

A multitude of approaches for the management of emptying cycles for the emptying of waste containers by measuring the filling level of the waste containers using different technologies have been disclosed. For example, German Patent No. DE 43 36 334 C1 (Deutsche Aerospace) describes a computer-controlled recycling container with a radio level indication system, in which a level sensor and radio components are produced in micro-assembly technology to detect and transmit fill level information about the fill level of the recycling container. The recycling container described in this document requires a specific design to accommodate the components necessary for sensing and communicating the fill level. A retrofittable solution being independent of design and material of the recycling container is not disclosed.

European Patent Application No. EP 0 626 569 A1 (Krone AG) relates to a method for monitoring the fill levels of containers of valuable materials. The document teaches a method enabling monitoring of the fill levels and emptying of the containers. The fill levels of the containers of valuable materials are detected by means of an electronic level sensor with a unidirectionally operating short-range broadcast module. The level data about the fill levels from the individual containers are transmitted at a defined time interval to a master container which serves as the communication hub and to which a broadcast modem is allocated. The master container sends the fill level data from the individual containers to a central control station for further processing, at a defined time interval, via a broadcast center. The method described relies on a specific container design to accommodate the components required.

European Patent Application No. EP 0 905 056 A1 (Alamelle et. al., assigned to Ecollect Sarl) describes a system for mechanically indicating the degree of filling of a container for solid waste. A palette partially obstructs a waste fall pipe into the waste container and tips as the waste enters the container. The palette is subjected to a return torque which returns the palette to a horizontal position after passage of the waste. An incremental impulse counter is connected to the palette by a mechanical actuator. The impulse counter counts and displays the number of waste disposals as a counter result. The system described relies on a specific arrangement to mechanically detect the fill level of the waste container.

US Patent Application No. US2019/0197498 (Gates et. al., assigned to Compology Inc.) A1 discloses a method for waste management, including recording an image of content within the waste container and extracting a set of content parameters from the image. The content within the waste container is characterized based on the set of content parameters. The information regarding the content is used for determining a purity value for every container equipped with this system. The purity value is compared to a purity threshold using the method described. A destination for the trash collected in the container is then defined according to the purity of the waste. The method described does not offer information regarding a more efficient waste collection by optimizing the timing for the emptying of the trash container.

European Patent Application EP 1 482 285 A1 (Badaroux et. al.) discloses a system for measuring the fill level of a waste container using ultrasound. A detector mounted in a trash container has an ultrasonic sensor for measuring a fill level of waste in a container. A communication unit transmits the fill level information to a remote receiver.

UK Patent Application GB 2 491 579 A (McSweeney) describes a waste collection system and method comprising trash containers equipped with a RFID detection unit and a communication unit. The communication unit is in contact with a trash collection operator. The RFID reader of the container detects the type of trash in the household's container and the communication module transmits a data message with Information relating to the trash in the household's container to the control center computer. Collection of trash is then scheduled by the control center computer to collect certain types of trash from the container. The trash containers may further detect odors using an olfactory sensor and the container may include a proximity sensor to detect rubbish adjacent the mouth of the container.

US Patent Application US 2018/128667 A1 describes a system for measuring a product quantity. The system comprises a first plurality of sensor assemblies and a second plurality of sensor assemblies. The second plurality of sensor assemblies are arranged laterally opposed to and aligned with the first plurality of sensor assemblies forming pairs of sensor assemblies. The pairs of sensor assemblies are configured to detect a presence of a product disposed between the pairs of sensor assemblies. The pairs of sensor assemblies are configured to detect the presence of the product in response to a compression force being applied to the pairs of the sensors. The pairs of the sensor assemblies transmit an output signal to a control element in response to the compression force being applied to the pairs of the sensors. The control element counts the output signal and converting the counted output signal into a digital representation of the product quantity.

International Patent Application WO 2019/144995 A1 (Zinn et. al., assigned to Zolitron Technology GmbH) relates to an energy-autonomous vibration measurement device which is designed to detect vibration measurement data of a device, for example a container, in an energy-autonomous manner. The device comprises an energy store for an autonomous energy supply and an energy receiving unit which is designed to supply energy harvested from the surroundings to the energy store. The device includes additionally a communication module which is coupled to the energy store and which is designed for a wireless energy-autonomous transmission of the vibration measurement data based on at least one communication protocol. The vibration measurement device is designed for an energy-autonomous detection and transmission of vibration measurement data. The vibration measurement data is transmitted in the form of sound measurement data detected on surface of the container. The vibration measurement device further has a computing unit and is additionally designed for an energy-autonomous analysis of the detected structure-borne sound measurement data. The fill level of the liquids or solids in the container is calculated using the vibration measurement. The document describes detection of the fill level using sound waves.

The prior art discloses solutions for measuring the fill level of waste (also called refuse or trash) in a container using direct and indirect detection sensor arrangements on, in and/or as part of a container. The solutions proposed in the prior art rely on complex and/or expensive sensor technology to reliably determine the fill level of a container. The prior art, however, does not disclose a system or method for the determination of a fill level of a container using robust, and low-cost sensor units which can be retrofitted on almost any type of container.

### SUMMARY OF THE INVENTION

The present document describes retrofittable, adaptable, and low-cost systems and methods for calculating a fill level of a container, deriving information on the fill level using the interaction data between the container and a person and/or an object gathered by a presence sensor arrangement and a fill status data model.

A container system for calculating a current fill status of a container is disclosed in the present document. The container system comprises a presence sensor arrangement for determining a plurality of presence sensor interactions with the container. The container system further comprises a local counting unit for recording numbers of the plurality of presence sensor interactions as presence sensor interaction data, and a local communication unit. A local communication unit transmits the presence sensor interaction data to a remote processing unit for calculating the current fill status.

The presence sensor interactions comprise interactions between a person coming close to the presence sensor arrangement or an object coming close to the presence sensor arrangement.

The presence sensor arrangement is installed on at least one of an outside of the container, on at least one of an aperture of the container, in at least one of an aperture of the container, on at least one of a wall of the container, or in close vicinity to the container.

The presence sensor arrangement comprises at least one of a capacitive approach sensor, a switch pressure sensor, a pressure mapping sensor, an optical sensor, or an acoustic sensor.

The container is, for example, a glass waste container, a paper waste container, an organic waste container, a plastic waste container.

A processing system for calculating a current fill status of a container is also disclosed in the present document. The processing system comprises a remote communication unit, a remote processing unit, and a fill status data model. The remote communication unit receives presence sensor interaction data. The remote processing unit processes the presence sensor interaction data. The remote processing unit comprises a fill status data model correlating the current fill status of the container with the presence sensor interaction data. The remote processing unit is adapted to issue a fill status signal. The fill status signal is representative of the current fill status of the container. The remote processing unit is adapted to transmit, using the remote communication unit, the fill status signal to, for example, a control center.

A method for calculating a current fill status of the container, using a plurality of presence sensor interactions, is also disclosed in the present document. The method comprises detecting, using a detection unit, the plurality of presence sensor interactions. The method also comprises recording the plurality of presence sensor interactions as a presence sensor interaction data in a local counting unit. The method further comprises transmitting the presence sensor interaction data from the local counting unit to a remote processing unit. The method further comprises processing the presence sensor interaction data using the remote processing unit. The method further comprises calculating the current fill status of the container from the processed presence sensor interaction data. The current fill status is calculated from the processed presence sensor interaction data using a fill status data model. The fill status data model comprises data correlating the fill status of the container with the presence sensor interaction data. The fill status signal indicative of the current fill status of the container. The method also comprises generating a fill status signal indicative of the current fill status of the container, calculated by the remote processing unit.

The detecting the plurality of presence sensor interactions comprises an interaction of, for example, at least one of a person or an object with the container. The plurality of the presence sensor interactions is detected using a presence sensor arrangement.

The processing the presence sensor interaction data comprises calibrating the fill status data model.

The updating of the fill status data model comprises adjusting the calculated current fill status of the container in the fill status data model by a deep learning algorithm, using at least one of a measured current fill status of the container and the plurality of current presence sensor interactions.

The predicting of the predicted fill status of the container comprises estimating the predicted fill status of the container as a function of time by using the current fill status of the container and the calibrated fill status data model.

The generating of the fill status signal comprises calculating at least one of the current fill status or the predicted fill status of the container as a fraction of the overall volume encompassed by the container. The fill status signal comprises the current fill status or the predicted fill status of the container or a requested collection time of the container.

A method for calculating a current fill status of a container and predicting a predicted fill status of a container, using a fill status data model, is also disclosed in the present document. The method comprises inputting a plurality of data relating to the current fill status of the container and a plurality of presence sensor interactions in the remote processing unit. The method further comprises correlating the current fill status with the plurality of presence sensor interactions using a machine learning algorithm and creating the fill status data model from the correlating of the current fill status.

The updating of the fill status data model comprises adjusting the fill status data model by a machine learning algorithm. The setting an initial value for the number of presence interactions required to fill the container comprises a manual measurement of the number of required presence sensor interaction or a calculation using the volume encompassed by the container and the average volume of the objects thrown in the container. Adjusting the fill status data model comprises processing at least one of a measured current fill status of the container and a predicted current fill status of the container by a machine learning algorithm.

The predicting of the predicted fill status of the container comprises estimating the predicted fill status of the container as a function of time.

The machine learning algorithm comprises at least one of a supervised deep learning algorithm, an unsupervised deep learning algorithm, or a reinforcement deep learning algorithm.

Measuring the current fill status of the container comprises at least one of a manual measurement, a weight measurement, or another detection of a current fill status of the container.

### DESCRIPTION OF THE FIGURES

FIG. 1 shows a view of a first aspect of a system for a container.

FIG. 2 shows a view of a second aspect of the system for the container.

FIG. 3 shows a flow chart describing a method for calculating a current fill status of the container.

FIG. 4 shows an example for the detection of the presence sensor interactions as a function of time.

FIG. 5 shows a flow chart describing a method for calculating a current fill status of a container and predicting a predicted fill status of a container using a fill status data model.

### DETAILED DESCRIPTION OF THE INVENTION

The invention will now be described on the basis of the figures. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

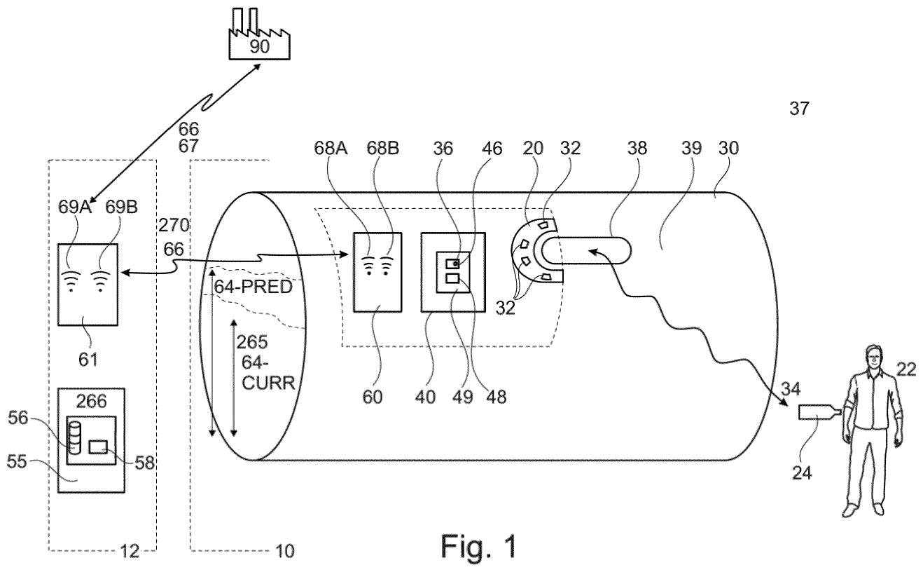

FIG. 1 shows a view of a first aspect of a container system 10, a processing system 12, and a control center 90. The container system 10 comprises a container 30, comprising a detection unit 20, a local counting unit 40 and a local communication unit 60. The container is, for example, a glass waste container, a paper waste container, an organic waste container, or a plastic waste container, but this is not limiting of the invention. The processing system 12 comprises a remote processing unit 55 and a remote communication unit 61.

The detection unit 20 comprises a presence sensor arrangement 32 for determining a plurality of presence sensor interactions 34 between the presence sensor arrangement 32 and one or more of a person 22 or an object 24. The presence sensor interactions 34 are, for example, an event and a duration which can be detected as a function of time.

The detection unit 20 is installed on an outside 37 of the container 30. The detection unit 20 is installed on or in an aperture 38 of the container 30 or on a wall 39 of the container 30.

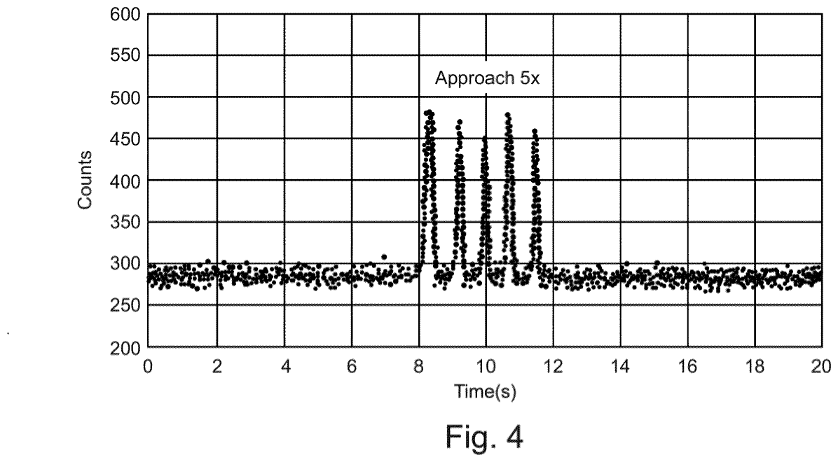

The presence sensor arrangement 32 comprises, for example, a capacitive approach sensor, a switch pressure sensor, a pressure mapping sensor, an optical sensor, or an acoustic sensor. The capacitive approach sensor determines the presence sensor interactions 34 based on the approach of the person 22 or the object 24 using capacitive sensing and records this information about the presence sensor interactions 34 as items of a presence sensor interaction data 36 in a local memory 46. The presence sensor interactions 34 are, for example, the person 22 coming close to the presence sensor arrangement 32 while disposing an object 24 in the container 30. One non-limiting example of the presence sensor interaction 34 would be the approach of a person's hand to deposit a glass bottle and/or other object 24 in the container 30. The presence sensor interactions 34, for example, can be detected as a spike in the capacitance as function over time when the presence sensor arrangement 32 comprises a capacitive approach sensor (as can be seen in FIG. 4). The presence sensor interactions 34 can also include signal changes in the capacitance due to environmental effects, for example rain or a stuck object 24 in or close to the presence sensor arrangement 32. Detections by the presence sensor arrangement 32 caused by environmental effects can be disregarded by the local counting unit 40. The presence sensor arrangement 32 can be, for example, printed in a roll to roll manner, thus potentially drastically reducing the cost of the sensor arrangement 32.

The local counting unit 40 comprises a local processor 48, a local memory 46, and a local circuit board 49. The local memory 46 is connected to the local processor 48. The local counting unit 40 stores the presence sensor interaction data 36 in the local memory 46.

The local communication unit 60 comprises a local sender 68A and a local receiver 68B. The local communication unit 60 transmits information related to a plurality of the presence sensor interactions 34 of the person 22 or the object 24 with the container 30 to a remote communication unit 61. The remote communication unit 61 comprises, for example, a remote sender 69A and a remote receiver 69B.

The remote processor 58 receives presence sensor interaction data 36 from the local counting unit. The remote processor 58 compares the presence sensor interaction data 36 to a fill status data model 56. A current fill status 64_CURR is calculated by the remote processor 58 as a function of the presence sensor interactions 34 and the fill status data model 56. The current fill status 64_CURR describes the calculated fill level of the container 30 at a given point in time. The current fill status 64_CURR can, for example, indicate the volume of the container 30 that is currently occupied by the filling material (like trash) expressed as a percentage of the total volume. The current fill status 64_CURR can be transmitted as a fill status signal 66 by the remote communication unit 61. The transmitted fill status signal 66 can be used by the control center 90 to obtain, for example, real time information of the current fill status 64_CURR of the container 30.

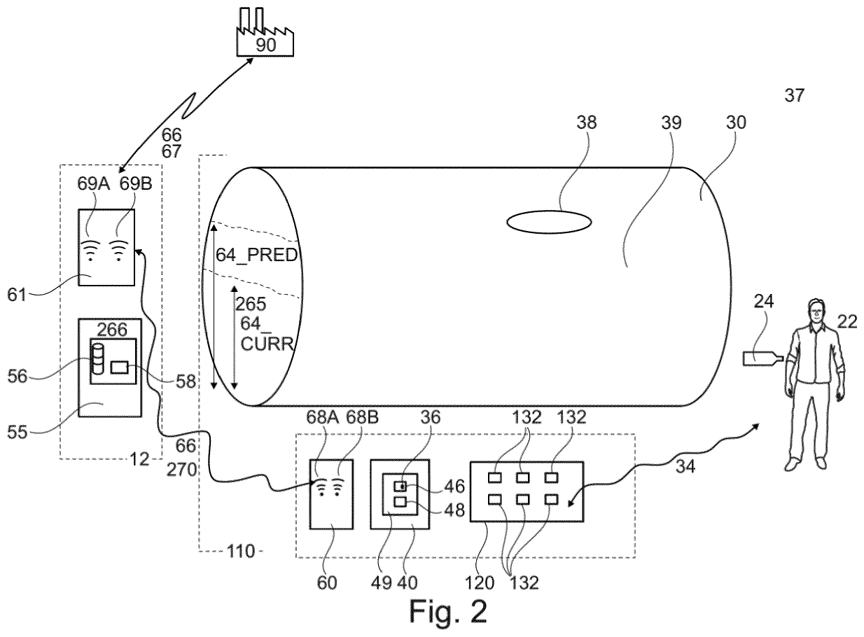

FIG. 2 shows a view of a second aspect of a container system 110. The container system 110 comprises the container 30, the detection unit 120, the local counting unit 40 and the local communication unit 60. The container system 110 for the container 30 has fundamentally the same structure and/or configuration as that of the container system 10 for the container 30 shown in FIG. 1 except for the structure and the location of the detection unit 120 relative to the container 30. Thus, elements having substantially the same function as those in the first aspect will be numbered the same here and will not be described and/or illustrated again in detail here for the sake of brevity.

The detection unit 120 comprises a presence sensor arrangement 132 for determining a plurality of the presence sensor interactions 34 between the presence sensor arrangement 132 and the person 22 or the object 24.

The detection unit 120 is installed in close vicinity to the container 30, for example, in front of the container 30.

The presence sensor arrangement 132 comprises, for example, a capacitive approach sensor, a switch pressure sensor, a pressure mapping sensor, an optical sensor, or an acoustic sensor. The presence sensor arrangement 132 determines presence sensor interactions 34 based on the approach of the person 22 or the object 24. The switch pressure sensor and/or the pressure mapping sensor can be a sensor mat placed in front of the container 30 and determine the presence sensor interactions 34 based on the weight force of the person 22 or the object 24 using pressure sensing and records this information about the presence sensor interactions 34 as items of the presence sensor interaction data 36 in the local memory 46.

The pressure mapping sensor, can, in a further aspect of the container system 10 shown in FIG. 2, be used to allow to record and recognize, using the local counting unit 40, patterns of interactions with the container 30. The pressure mapping sensor can, for example, determine the type of presence sensor interactions 34. Examples of presence sensor interactions 34 being an approach of the person 22 throwing one or more of the objects 24 into the container 30 or an arrival of a vehicle carrying objects for the container. The pressure mapping sensor can also be used to determine the change of weight of the person 22 interacting with the presence sensor arrangement 132. The presence sensor interactions 34, for example, can be detected as a spike in the pressure as function over time when the presence sensor arrangement 132 comprises a switch pressure sensor or a pressure mapping sensor. The presence sensor interactions 34 can be used to calculate the current fill status 64_CURR by the remote processing unit 55 assuming a Gaussian distribution for the probability of the volumes deposited by the person 22.

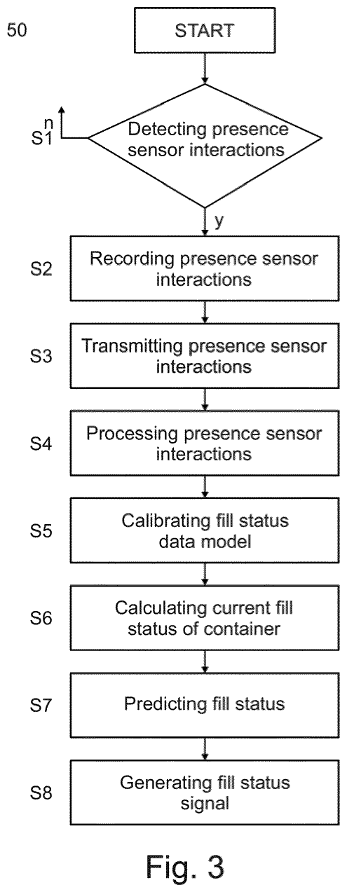

FIG. 3 shows a flow chart describing a method 50 for calculating the current fill status 64_CURR of the container 30. The presence sensor arrangement 32, 132 detects the presence sensor interactions 34 of the container 30 with the person 22 or the object 24 (Step S1).

The local counting unit 40 records the number of the presence sensor interactions 34 as items of the presence sensor interaction data 36 in the local memory 46. An increment is added to the current counter value for the presence sensor interactions 34 by the local counting unit 40 for each of the presence sensor interactions 34. The addition of the increment to the previous presence sensor interaction data 36, N follows the function

N*=N+1

yielding the current presence sensor interactions 36, N*. A non-limiting example for the presence sensor interactions 34 would be the approach of a person's hand to deposit a glass bottle into the container 30 (Step S2).

The fill status signal 66, for example, comprises numbers of the plurality of presence sensor interactions 34 stored as presence sensor interaction data 36. The local counting unit 40 transmits the fill status signal 66 to a remote receiver 69B using the local sender 68A (Step S3).

The remote processing unit 55 processes the presence sensor interaction data 36 (Step S4).

The calibrating of the fill status data model 56 comprises adjusting the calculated current fill status 64_CURR of the container 30 in the fill status data model 56 by a deep learning algorithm, using at least one of a measured current fill status 64_CURR of the container 30 and the plurality of current presence sensor interactions 34. Measuring the current fill status 64_CURR of the container 30 comprises at least one of a manual measurement, a weight measurement, or another detection of a current fill status 64_CURR of the container (Step S5).

The remote processing unit 55 calculates the current fill status 64_CURR of the container 30 from the processed items of the presence interaction data 36 using a fill status data model 56, wherein the fill status data model 56 comprises data correlating the fill status of the container 30 with the presence sensor interaction data 36. The successive filling of the container 30 as a function of time can be calculated using the fill status data model 56 (Step S6).

The remote processing unit 55 predicts the predicted fill status 64_PRED of the container 30 by estimating the predicted fill status 64_PRED of the container 30 as a function of time, using the current fill status 64_CURR of the container 30 and the calibrated fill status data model 56 (Step S7)

The remote processing unit 55 generates the fill status signal 66 indicative of the current fill status 64_CURR of the container 30 by generating the fill status signal 66 comprises at least one of calculating the current fill status 64_CURR or the predicted fill status 64_PRED of the container 30 as a fraction of the overall volume encompassed by the con-lather 30 (Step S8).

In one non-limiting example, the container system 10, 110 can be configured to detect different types of the object 24 disposed in the container 30. Two of the containers 30 in different locations might, for example, be filled with bottles. A first one of the containers might show a different current fill status 64_CURR after an identical number of presence sensor interactions 34 than a second one of the containers 30. This is probably caused by different types of bottles being disposed in the first one of the containers 30 than in the second one of the containers 30. The bottles disposed in the first one of the containers 30 might be generally of a different size and weight and/or shatter more easily than the bottles disposed in the second one of the containers 30. The remote processing unit 55 can, using the deep learning algorithm, adjust over time the fill status data model 56 accordingly to give different values for predicted fill status 64_PRED of the first one and the second one of the containers 30. This allows the fill status data model 56 to reflect the different types of bottles disposed in the containers 30 and adjust the intervals between emptying of the containers 30.

FIG. 4 shows an example for the detection of the presence sensor interactions. The graph shows a count of the items of presence sensor interactions 34 as a function of time. The presence sensor interactions 34 can be detected using a capacitive presence sensor arrangement. The presence sensor interactions 34 can be processed using an analog-to-digital converter (ADC), counting the items of presence sensor interactions 34 as a function of time. Each of the presence sensor interactions 34 can be characterized by a spike in capacitance detected by the presence sensor arrangement 32. In an initial setup, the ADC can be set to detect the items of presence sensor interactions 34 as the number of times, when a threshold value for the capacitance is exceeded. In a further adjustment of the system and method, more complex functions can be used for determining the exceeding of a threshold value or for the threshold value itself

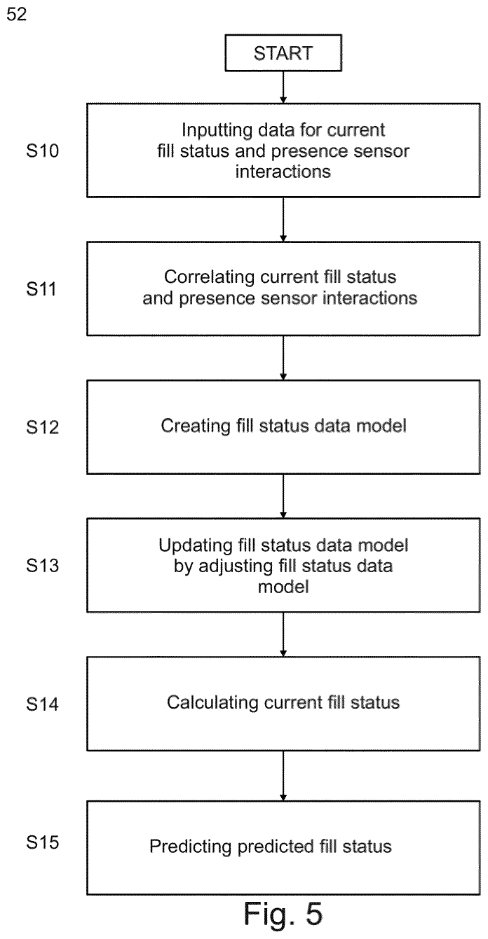

FIG. 5 shows a flow chart describing a method 52 for calculating a current fill status of a container and predicting a predicted fill status of a container using a fill status data model. A plurality of data relating to the current fill status 64_CURR of the container 30 and a plurality of presence sensor interactions 34 are input in the remote processing unit 55 (Step S10).

The current fill status 64_CURR of the container 30 is correlated with the plurality of presence sensor interactions 34 by the remote processing unit 55 using a machine learning algorithm (Step S11).

The fill status data model 56 is created from the correlating of the current fill status 64_CURR (Step S12).

The fill status data model 56 is updated by adjusting the fill status data model 56 using the presence sensor interaction data 36. Based on evaluation of the container 30, an initial value for the number of presence sensor interactions 34 required to fill the volume encompassed by the container 30 is defined. Initial calibrating comprises setting the initial value for the number of presence sensor interactions 34 necessary for the current fill status 64_CURR or the predicted fill status 64_PRED to reach a threshold value, being indicative for the container 30 being full (Step S13).

The current fill status 64_CURR is calculated using the calibrated fill status model 56 and the presence sensor interaction data 36 (Step S14).

The predicted fill stats 64_PRED is calculated using the calibrated fill status model 56 and the presence sensor interaction data 36 (Step S15).

### REFERENCE NUMERALS

10 container system
12 processing system
110 system
20 detection unit
120 detection unit
22 person
24 object
30 container
32 presence sensor arrangement
132 presence sensor arrangement
34 presence sensor interactions
36 presence sensor interaction data
37 outside
38 aperture
39 wall
40 local counting unit
46 local memory
48 local processor
49 local circuit board
50 method
52 method
55 remote processing unit
56 fill status data model
58 remote processor
60 local communication unit
61 remote communication unit
64_CURR current fill status
64_PRED predicted fill status
66 fill status signal
67 requested collection time
68A local sender
68B local receiver
69A remote sender
69B remote receiver
90 control center

1. A container system for calculating a current fill status of a container using a plurality of presence sensor interactions, the container system comprising:
a presence sensor arrangement for calculating the plurality of presence sensor interactions with the container;
a local counting unit for recording numbers of the plurality of presence sensor interactions as presence sensor interaction data;
a local communication unit for transmitting the presence sensor interaction data to a remote processing unit for processing the presence sensor interaction data and calculating the current fill status; and
predicting a predicted fill status of the container in the remote processing unit by estimating the predicted fill status of the container as a function of time.

2. The container system according to claim 1, wherein
the presence sensor interactions comprise interactions between a person coming close to the presence sensor arrangement or an object coming close to the presence sensor arrangement.

3. The container system according to claim 1, wherein
the presence sensor arrangement is installed on at least one of an outside of the container, on an aperture of the container, in an aperture of the container, on a wall of the container, or in close vicinity to the container.

4. The container system according to claim 1, wherein
the presence sensor arrangement comprises at least one of a capacitive approach sensor, a switch pressure sensor, a pressure mapping sensor, an optical sensor, or an acoustic sensor.

5. The container system according to claim 1, wherein
the container comprises at least one of a glass waste container, a paper waste container, an organic waste container, a plastic waste container.

6. A processing system for calculating a current fill status of a container using a plurality of presence sensor interactions, the processing system comprising:
a remote communication unit for receiving presence sensor interaction data from the container;
a remote processing unit comprising a fill status data model wherein the fill status data model comprises data correlating the current fill status of the container with the presence sensor interaction data;
wherein the remote processing unit is adapted to issue a fill status signal representative of the current fill status of the container; and
wherein the remote processing unit is adapted to transmit, using the remote communication unit, the fill status signal to a control center.

7. A method for calculating a current fill status of a container using a plurality of presence sensor interactions, the method comprising,
detecting, using a detection unit, the plurality of presence sensor interactions;
recording numbers of the plurality of presence sensor interactions as a presence sensor interaction data in a local counting unit;
transmitting the presence sensor interaction data from the local counting unit to a remote processing unit;
processing the presence sensor interaction data using the remote processing unit;
calculating the current fill status of the container from the processed presence sensor interaction data using a fill status data model, wherein the fill status data model comprises data correlating the fill status of the container with the presence sensor interaction data; and
generating a fill status signal indicative of the current fill status of the container, calculated by the remote processing unit.

8. The method according to claim 7, wherein
detecting the plurality of presence sensor interactions comprises a detected interaction, using a presence sensor arrangement, of at least one of a person or an object with the container.

9. The method according to claim 7, wherein
processing the presence sensor interaction data comprises updating the fill status data model.

10. The method according to claim 7, wherein
updating the fill status data model comprises adjusting the calculated current fill status of the container in the fill status data model by a deep learning algorithm, using at least one of a measured current fill status of the container and the plurality of current presence sensor interactions.

11. The method according to claim 7, wherein
predicting the predicted fill status of the container comprises estimating the predicted fill status of the container as a function of time, using the current fill status of the container and the calibrated fill status data model.

12. The method according to claim 7, wherein
generating the fill status signal comprises calculating at least one of the current fill status or the predicted fill status of the container as a fraction of the overall volume encompassed by the container.

13. The method according to claim 7, wherein
the fill status signal comprises at least one the current fill status or the predicted fill status of the container or at least one of a requested collection time of the container.

14. A method for creating a fill status data model for enabling predicting a predicted fill status of a container using the fill status data model, the method comprising:
inputting a plurality of data relating to the current fill status of the container and a plurality of presence sensor interactions in the remote processing unit;
correlating the current fill status with the plurality of presence sensor interactions using a machine learning algorithm; and
creating the fill status data model from the correlating of the current fill status.

15. The method according to claim 14, further comprising:
updating the fill status data model by adjusting the fill status data model by a machine learning algorithm; and
adjusting the fill status data model comprises processing, using at least one of a plurality of presence sensor interactions at least one of a measured current fill status of the container and at least one of a predicted current fill status of the container, by a machine learning algorithm.

16. The method according to claim 14, wherein
predicting the predicted fill status of the container comprises estimating the predicted fill status of the container as a function of time.

17. The method according to claim 14, wherein
the machine learning algorithm comprises at least one of a supervised deep learning algorithm, an unsupervised deep learning algorithm, or a reinforcement deep learning algorithm.

18. The method according to claim 14, wherein
measuring the current fill status of the container comprises at least one of a manual measurement, a weight measurement, or another detection of a current fill status of the container.
